(19) United States
(12) Patent Application Publication
(10) Pub. No.: US 2024/0144099 A1
(43) Pub. Date: May 2, 2024

(54) METHOD AND DEVICE FOR CURATING LIQUOR AND FOOD BASED ON FLAVOR DATA USING A PLURALITY OF ARTIFICIAL INTELLIGENCE MODELS

(71) Applicant: Daegeun LEE, Seoul (KR)

(72) Inventor: Daegeun LEE, Seoul (KR)

(21) Appl. No.: 18/491,756

(22) Filed: Oct. 21, 2023

(30) Foreign Application Priority Data
Oct. 31, 2022 (KR) 10-2022-0142268

(51) Int. Cl. G06N 20/00

(52) U.S. Cl. CPC G06N 20/00

(57) ABSTRACT

A method and device for curating liquor (and other alcohol/alcoholic beverages) and food based on flavor data using a plurality of artificial intelligence models are provided. The method comprises: receiving a food recommendation request including a user's alcohol preference information from a user device; generating curation data, using at least one of the alcohol preference information, pre-stored matching data between alcohol and food, and user data, based on an artificial-intelligence-based first learning model; and displaying information about recommended food on a screen of the user device, using the curation data.

### TECHNICAL FIELD

The present disclosure relates to a method and device for curating liquor (i.e., alcohol) and food, based on flavor data using a plurality of artificial intelligence model(s).

### BACKGROUND ART

Recently, as the types of alcohol (e.g., liquor and other alcoholic beverages) and food have become more diverse and information about them has become available in various ways, consumers' tastes and preferences for alcohol and food are also becoming more diverse and refined.

With these changes, interest in pairing alcohol and food is growing. Pairing alcohol and food is an act of pairing each other harmoniously. Pairing alcohol and food means finding which alcohol and food goes well together by considering various factors such as taste, aroma, texture, and temperature. Therefore, a platform that pairs alcohol and food according to consumers' tastes and preference is needed.

### SUMMARY OF THE INVENTION

### Technical Problem

An object of the embodiments in the present disclosure is to provide a method and device for curating alcohol (liquor, alcoholic beverages) and food, based on flavor data using a plurality of artificial intelligence models.

Technical problems to be solved by the present disclosure are not limited by the technical object described herein, and non-described or other technical objects may be clearly understood by a person having ordinary skill, based on the disclosure below.

### Solutions to Problem

To attain the above and other technical objects (not discussed), a method for curating alcohol and food, based on flavor data using a plurality of artificial intelligence model(s), according to an embodiment of the present disclosure, may comprise: receiving a food recommendation request including a user's alcohol preference information from a user device; generating curation data using at least one of the alcohol preference information, pre-stored matching data between alcohol and food, and user data, based on an artificial-intelligence-based first learning model; and displaying information about recommended food on a screen of the user device, using the curation data; wherein the matching data generates by an artificial-intelligence-based second learning model learning a plurality of alcohol data and a plurality of food data according to a preset correlation based on the flavor data.

According to an embodiment, the artificial-intelligence-based second learning model may be learned so that a first probability that a first alcohol and a first food are related and a second probability that a second alcohol and the first food are related are different on a Graph Network.

According to an embodiment, the method may further comprise searching similar-product data by using product data, based on an artificial-intelligence-based third learning model.

According to an embodiment, when the product data is alcohol name information received from the user device, the similar-product data may be searched by the third learning model learned through data querying; and when the product data is an alcohol image received from the user device, the similar-product data may be searched by the third learning model learned through object detection and classification within the image.

According to an embodiment, the curation data related to at least one food that suits the user's alcohol preference may be generated based on an item-based recommendation algorithm.

According to an embodiment, the item-based recommendation algorithm may calculate a matching score with an alcohol for each of the at least one food matched to the alcohol corresponding to the alcohol preference information, based on the user data, and create a recommendation list from the curation data with the matching score arranged in decreasing order or rank.

According to an embodiment, by using the item-based recommendation algorithm, at least one recommended alcohol that has a flavor similar to the alcohol corresponding to the user's alcohol preference information may be extracted, and the matching score with the corresponding alcohol may be calculated for the at least one food matched to each of the recommended alcohols, based on the user data, and the food with a highest matching score may be extracted as the recommended food with respect to each of the recommended alcohols.

According to an embodiment, a first UI (User Interface) may be displayed on the screen and configured: to arrange an image of a food corresponding to a first or the highest rank in the recommendation list in a first region, and to sequentially arrange images of foods corresponding to a second or second highest rank to a preset rank in the recommendation list in a second region. Also, a second UI (User Interface) may be displayed on the screen and configured to match each image of the recommended alcohols and each image of the recommended foods extracted for each of the recommended alcohols, and arrange the matched images in a third region.

Further, to attain the technical objects, according to yet another embodiment of the present disclosure, a device for curating alcohol and food, based on flavor data using a plurality of artificial intelligence model(s), may comprise: a communication unit; a memory storing at least one process for the flavor-data-based curating using a plurality of artificial intelligence models; and a processor operating according to the process; wherein the processor receives the food recommendation request containing the user's alcohol preference information from the user device through the communication unit, and based on the artificial-intelligence-based first learning model, generates the curation data by using at least one of the alcohol preference information, previously stored matching data between alcohol and food, and the user data, and displays information about the recommended foods on the screen of the user device, by using the curation data; and the matching data is generated by an artificial-intelligence-based second learning model, learning a plurality of alcohol data and a plurality of food data based on a correlation preset based on the flavor data.

In addition, a computer program, which is stored in a computer-readable recording medium for executing (an implementation) to implement the present disclosure may be further provided.

In addition, a computer-readable recording medium, which records a computer program for executing a method for implementing the present disclosure may be further provided.

### Advantageous Effects of Invention

According to the solution for solving the above-described problem of the present disclosure, by recommending food that suits the user's alcohol preference based on flavor data, the user may consume food and alcohol as a set having harmonious bouquet of flavors.

Additionally, by recommending alcohol with flavors similar to the user's alcohol preference, the user may obtain information about alcohol of his or her preference that he or she did not know about.

Advantageous effects of the present disclosure are not limited to the effects mentioned above, and other effects not mentioned will be clearly understood by those skilled in the art from the detailed description and the claims below.

### BRIEF DESCRIPTION OF DRAWINGS

FIG. 1 is a diagram schematically showing a system for providing flavor data based alcohol and food curating services according to the present disclosure.

FIG. 2 is a schematic configuration diagram of flavor data based alcohol and food curating device according to the present disclosure.

FIG. 3 is a flowchart of flavor data based alcohol and food curating method according to the present disclosure.

FIG. 4 is a diagram illustrating a plurality of artificial intelligence models used to generate curation data according to the present disclosure.

FIG. 5 is a diagram for illustrating food data according to the present disclosure.

FIG. 6 is a diagram for illustrating alcohol (alcoholic beverages) data according to the present disclosure.

FIG. 7 is a diagram for illustrating matching data according to the present disclosure.

FIG. 8 and FIG. 9 are diagrams for illustrating a user interface according to the present disclosure.

### DETAILED DESCRIPTION

Throughout the specification, same/similar reference numerals are used for the same/similar components or elements in the drawings. Not all of the components or elements are described in the disclosed embodiments, and redundant or overlapping descriptions among the embodiments, or the common terms or general knowledge and descriptive matters in the technical field or art to which the present disclosure pertains to, are omitted.

The terms “′unit, module, member, and block” used in the present specification may be implemented as software or hardware, and according to or depending on an embodiment, a plurality of “units, modules, members, and/or blocks” may be implemented as a single element. It is also possible for one “part, module, member, or block” to include multiple components or elements.

Throughout the specification, when one element is described as being “joined (linked, connected, combined)” to another element, this includes not only the case of being “directly joined” but also the case of being “indirectly joined” with another, 3^{rd} element (for example, a wireless communication network) there between.

Also, when an element is described to “comprise, include, or having” another element, this means not that one element is excluded but that another element may be further included, unless there is a specific disclosure to the contrary. The language “comprising,” “including,” “having,” etc. are intended to indicate the presence of described features, numbers, steps, operations, elements, and/or components, and should not be interpreted as precluding the presence or addition of one or more of other features, numbers, steps, operations, elements, components, and/or grouping or combination thereof.

Throughout the specification, when a member is said to be located “on” another member, this includes not only cases where a member is in contact with another member, but also cases where another member exists between the two members.

Terms such as 1^{st} (first) and, 2^{nd} (second) may be used to distinguish one element from another element, and the element(s) are not limited by the described terms.

Terms used to express singular forms includes the plural forms as well, unless the context clearly indicates otherwise.

The reference numerals for each of the steps is used for convenience of description and explanation. The reference numerals do not describe the order of each step, and each step may be performed differently from the specified order unless a specific order is clearly stated in the context.

Hereinafter, operating principles and embodiments of the present disclosure are described (in detail) with reference to the accompanying drawings.

In the present specification, “device” or “apparatus” includes all various devices or apparatuses that may perform computational processing and provide results to the user. For example, the device in the present disclosure may include all of a computer, a server device, and a portable terminal, or may take the form of any one of them.

Here, the computer may include, for example, a notebook, desktop, laptop, tablet PC, slate PC, etc. equipped with a web browser.

The server device may be a server that processes information by communicating with external devices, and may include an application server, computing server, database server, file server, game server, mail server, proxy server, and web server.

The portable terminal may, for example, be a wireless communication device that guarantees portability and mobility, and may include all types of handheld wireless communication devices, such as PCS (Personal Communication System), GSM (Global System for Mobile communications), PDC (Personal Digital Cellular), PHS (Personal Handyphone System), and PDA. (Personal Digital Assistant), IMT (International Mobile Telecommunication)-2000, CDMA (Code Division Multiple Access)-2000, W-CDMA (W-Code Division Multiple Access), WiBro (Wireless Broadband Internet) terminals, smart phones, and wearable devices such as watches, rings, bracelets, anklets, necklaces, glasses, contact lenses, or head-mounted-device (HMD).

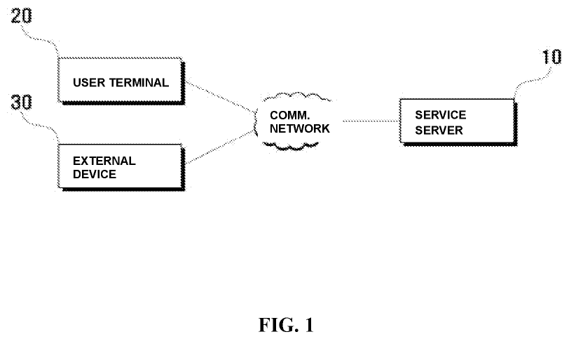

FIG. 1 is a diagram schematically showing a system for providing flavor data based alcohol and food curating services according to the present disclosure.

Referencing FIG. 1, the system according an embodiment of the present disclosure may comprise a service server (10), a user terminal or device (20), and an external device (30).

However, in some embodiments, the system may comprise fewer elements or more elements than those shown in FIG. 1.

The service server (10) refers to a server of a company that provides alcohol and food curating services to users through a service platform.

The service server (10) provides services in the form of an online web or app, and may transmit and receive various information with at least one of the user device (20), the external device (30), and an external server (not shown) through the online web or app.

The user terminal or device (20) refers to a terminal device of a user using the service. The user may install the service application (program) provided by the service server (10) on the user device (20) and use the service in the form of an online web or app.

Here, the user device (20) may have an information processing means or function like a computer and input/output means or function including a control unit such as a processor, a photographing unit such as a camera, and a touch screen, and may refer to any device which includes a communication function. In other words, it may apply to any device such as a smartphone, tablet, PDA, laptop, desktop, etc.

The input means is for receiving information from the user, and when information is input, the control unit may control the operation of the (curating) device to correspond to the input information. The input means may include hardware-type physical keys (e.g., buttons, dome switches, jog wheels, jog switches, etc. located on at least one of the front, back, and sides of the user device) and software-type touch keys. As an example, the touch keys may be a virtual key, soft key, or visual key displayed on a touch screen-type display unit through software processing, or touch keys arranged on a part other than the touch screen. The virtual key or visual key may be displayed on the touch screen in various forms, for example, graphic, text, icon, video or a combination thereof.

The output means is for generating output related to vision, hearing, or tactile sensation, and may include at least one of a display unit, an audio output unit, a haptic module, and an optical output unit. The touch screen may be implemented by being formed in a layered structure with a touch sensor or being integrated with the display unit. Such touch screen may function as a user input unit that provides an input interface between the user device and the user, and at the same time, provide an output interface between the user device and the user.

The display unit displays (outputs) information processed in the user device. For example, the display unit may display execution screen information of a program(for example, an application) running on the user device, or UI (User Interface) and GUI (Graphic User Interface) information according to the execution screen information.

The camera processes image frames, such as still images or moving images, obtained by an image sensor in recording mode. The processed image frames may be displayed on the display unit (or a/the screen of the user device) or stored in memory.

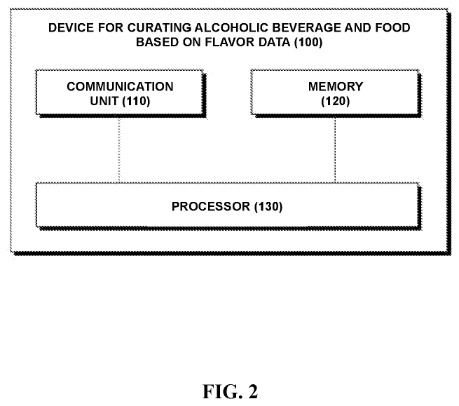

FIG. 2 is a schematic configuration diagram of flavor data based alcohol and food curating device according to the present disclosure.

Referencing FIG. 2, the flavor data based alcohol and food curating device (hereinafter, curating device) may comprise a communication unit (110), a memory (120), and a processor (130).

However, in some embodiments, the curating device (100) may comprise fewer elements or more elements that those shown in FIG. 2. The curating device (100), which is described with reference to FIG. 2, may be the service server (10) which was described with reference to FIG. 1.

The communication unit (110) may comprise one or more element(s) that enables communication with the user device (20) or the external device (30), and may include at least one of a wired communication module, a wireless communication module, a short-range communication module, and a location information module.

The wired communication module may include not only various wired communication modules such as Local Area Network (LAN) modules, Wide Area Network (WAN) modules, or Value Added Network (VAN) modules but also various cable communication modules such as USB (Universal Serial Bus), HDMI (High Definition Multimedia Interface), DVI (Digital Visual Interface), RS-232 (recommended standard 232), power line communication, or POTS (plain old telephone service), etc.

In addition to Wi-Fi modules and WiBro (Wireless broadband) modules, the wireless communication module may include a wireless communication module that supports various wireless communication methods, such as GSM (global System for Mobile Communication), CDMA (Code Division Multiple Access), WCDMA (Wideband Code Division Multiple Access), and UMTS (universal mobile telecommunications system).), TDMA (Time Division Multiple Access), LTE (Long Term Evolution), 4G, 5G, 6G, etc.

The short-range communication module is for short-range communication and may use at least one of Bluetooth™, RFID (Radio Frequency Identification), Infrared Data Association (IrDA), UWB (Ultra Wideband), ZigBee, and NFC (Near Field). Communication), Wi-Fi (Wireless-Fidelity), Wi-Fi Direct, and Wireless USB (Wireless Universal Serial Bus) technology to support a short-distance communication.

The memory (120) may store at least one process for providing flavor data based alcohol and food curating services using a plurality of artificial intelligence models.

The memory (120) may store data supporting various functions of the curating device (100) and a program for an operation of the processor (130), and input/output data (e.g., music files, still images, videos, etc.), and a plurality of programs (application programs or applications) running on the curating device (100), and data for an operation of the curating device (100), and commands. At least some of these applications may be downloaded from an/the external server via wireless communication.

Such memory (120) may include at least one type of storage medium among a flash memory type, a hard disk type, a solid state disk type, an SDD type (Silicon Disk Drive type), a multimedia card micro type, a card type memory (e.g., SD or XD memory, etc.), random access memory (RAM), static random access memory (SRAM), read-only memory (ROM), and EEPROM (electrically erasable programmable read-only memory), programmable read-only memory (PROM), magnetic memory, magnetic disk, and optical disk. Additionally, the memory (120) is separate(d) from the curating device (100) but may be a database connected by wire or wirelessly.

The processor (130) may perform the above-described operations using a memory that stores data for an algorithm for controlling the operation of the elements in/within the curating device (100) or a program that reproduces the algorithm, and the data stored in the memory. At such time, the memory (120) and the processor (130) may each be implemented as separate chips. Alternatively, the memory (120) and processor (130) may be implemented as a single chip.

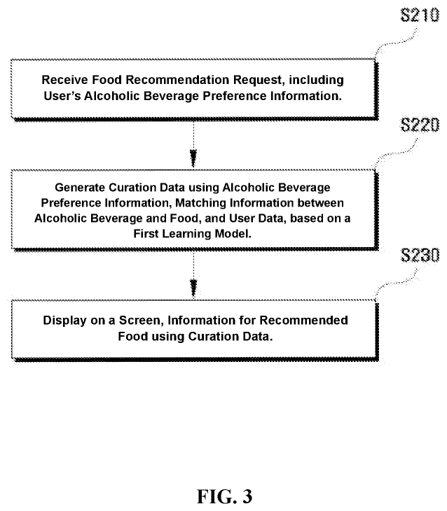

In addition, the processor (130) may control any one or a combination of a plurality of components or elements in order to implement on the curating device (100), various embodiments according to the present disclosure as described in FIG. 3 to FIG. 9.

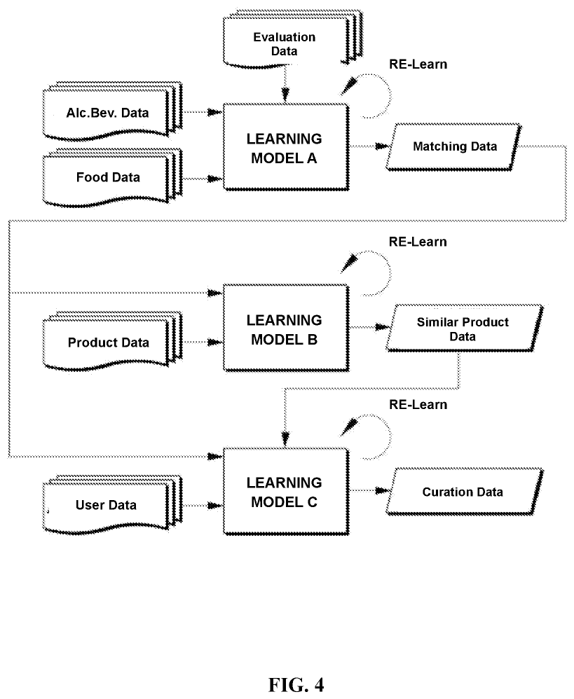

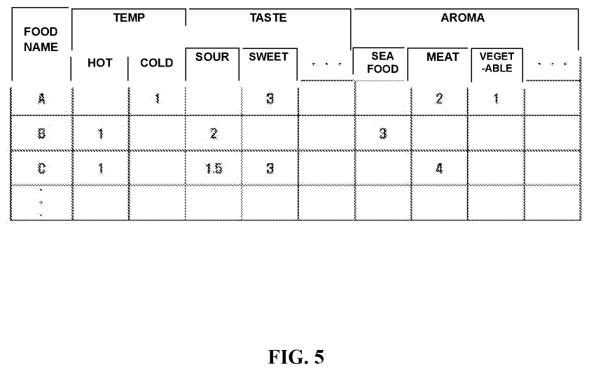

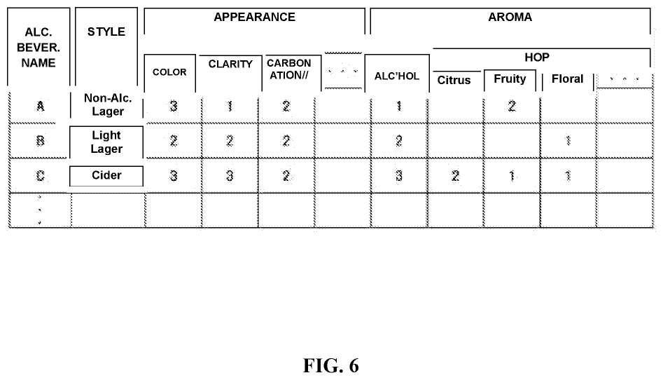

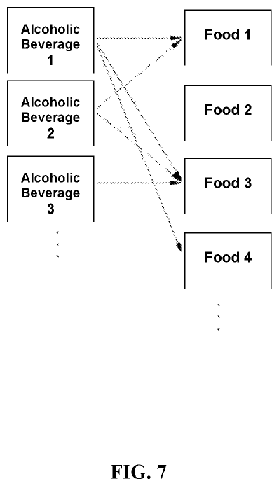

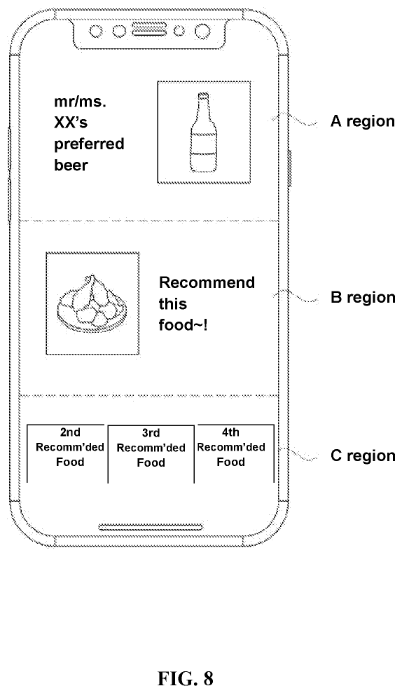

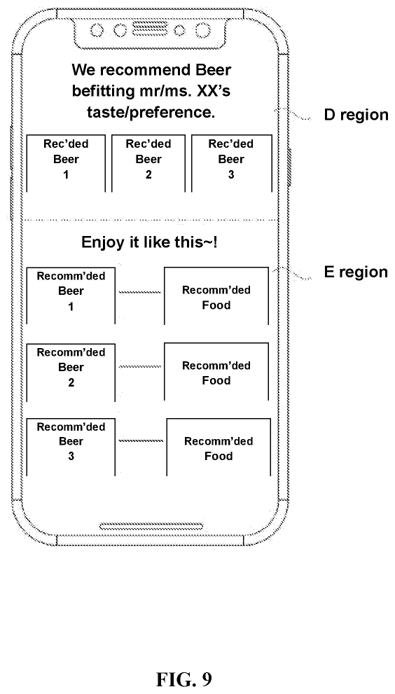

FIG. 3 is a flowchart of flavor data based alcohol and food curating method according to the present disclosure. FIG. 4 is a diagram illustrating a plurality of artificial intelligence models used to generate curation data according to the present disclosure. FIG. 5 is a diagram for illustrating food data according to the present disclosure. FIG. 6 is a diagram for illustrating alcohol (alcoholic beverages) data according to the present disclosure. FIG. 7 is a diagram for illustrating matching data according to the present disclosure. FIG. 8 and FIG. 9 are diagrams for illustrating a user interface according to the present disclosure.

Hereinafter, the method of FIG. 3 is described as being performed by the curating device (100), but the method is not limited thereto and may also be understood as being performed by the service server (10) of FIG. 1.

Referencing FIG. 3, the processor (130) of the curating device (100) receives a food recommendation request including the user's alcohol preference information from the user device (20) through the communication unit (110). (S210)

The processor (130) of the curating device (100) generates curation data based on an artificial intelligence based first learning model using at least one of alcohol preference information, pre-stored matching (e.g., pairing) data between alcohol and food, and user data. (S220)

The processor (130) of the curating device (100) displays information about recommended food on the screen of the user device (20) using the curation data. (S230)

Detailed Description of Step S210

The processor (130) receives the food recommendation request from the user device (20), and at such time, the user's alcohol preference information may also be received.

Here, the alcohol preference information is information about the user's favorite (alcoholic) product and may include at least one of the product′ name, type, alcohol content, main ingredient, and product image.

Depending on an embodiment, the alcohol preference information may be input at a time when the user requests the food recommendation through the user device (20).

Depending on an embodiment, the alcohol preference information may also be input at a time when the user signs up for the service platform through the user device (20).

Detailed Description of Step S220

When the food recommendation request is received, the processor (130) may input at least one of the alcohol preference information, the matching data between alcohol and food, and the user data to a pre-arranged/configured artificial-intelligence-based first learning model (Learning Model C shown in FIG. 4) and output the curation data.

Here, the matching data may be generated as an artificial-intelligence-based second learning model (Learning Model A shown in FIG. 4) learns a plurality of alcohol data and a plurality of food data according to a preset correlation or association based on the flavor data. At such time, the plurality of alcohol data and the plurality of food data used as learning data of the second learning model may be received from the external device (30).

Referencing FIG. 5, the food data may refer to data expressed in numbers by analyzing temperature, taste, and aroma of each food. At such time, the analysis criteria may be further divided into a criteria other than the temperature, taste, and aroma, and likewise, each criterion may be subdivided and more detailed than as shown in FIG. 5 (for example, the TASTE criterion may be subdivided into SALTY taste and HOT (spicy) taste (not shown) in addition to SOUR taste and SWEET taste). To note, the numerical value of a degree of each criterion in FIG. 5 is provided only for illustrative purposes, and there is no limitation on a form or range of the value.

Referencing FIG. 6, the alcohol data may refer to data expressed in numbers by analyzing a style, appearance, and scent or aroma of each alcohol (e.g., liquor, alcoholic beverage). At such time, the analysis criteria may be further divided into a criteria other than the style, appearance, and aroma, and likewise, each criterion may be subdivided and more detailed than as shown in FIG. 6 (for example, the APPEARANCE criterion may be subdivided into FOAM PERSISTENCE (not shown), in addition to the COLOR, CLARITY, and CARBONATION). To note, the numerical value of a degree of each criterion in FIG. 6 is also only for illustrative purposes, and there is no limitation on the form or range of the value.

In these regard, all food and alcohol have their own flavor, and the second learning model may generate the matching data between alcohol and food according to the preset association, using the flavor data included in each of the alcohol data and the food data.

Depending on an embodiment, the association may be set so that: flavor A of an alcohol has a high correlation (i.e., correlation decreases) in an (sequential) order of flavor a, flavor b, and flavor c of a food; and flavor B of an/the alcohol has a high correlation in an order of flavor d, flavor b, and flavor a of a food. Based on the association set in this way, if main flavors of a certain alcohol are flavor A and flavor B, a food that contains a/the highest proportion of flavor a and flavor d (i.e., the flavor(s) having the highest correlation respectively, with respect to each of flavor A and flavor B) is first extracted respectively, with respect to flavor A and flavor B; and then a food that contains a high proportion of the second highest correlation, flavor b, and the third highest correlation, flavor c, is/are secondarily extracted, and the matching data with the certain alcohol may be generated.

Here, since flavor a was considered during the first extraction, it was excluded during the second extraction; however, depending an embodiment, after the second extraction of a food with a high proportion of flavor b and flavor c, among them, a food with a higher proportion of flavor a may also be extracted in a third extraction.

In this regard, by using each alcohol and food as a node, a graph representing a/the matching relationship between an alcohol and a food may be generated. Referencing FIG. 7, Alcoholic Beverage 1 was linked (matched) with Food 1, Food 3, and Food 4; Alcoholic Beverage 2 was linked (matched) with Food 1 and Food 3; and Alcoholic Beverage 3 was linked (matched) with Food 3.

At such time, the second learning model may be learned or trained so that a probability of inferring the alcohol (input) linked to the food (output) differs by more than a first threshold. That is, referencing FIG. 7, the network may be trained so that a first probability that Alcoholic Beverage 1 is associated with Food 1 and a second probability that Alcoholic Beverage 2 is associated with food 1 are different. Expressing this as a conditional probability, P(food_q|alcohol_p1)≠P(food_q|alcohol_p2).

The processor (130) may generate the curation data related to at least one food that suits the user's alcohol preference based on an item-based recommendation algorithm generated through learning of the first learning model.

Here, the first learning model may implement an item-based recommendation algorithm by performing learning using internal variables (age, gender, weighted value of preference, etc.), external variables (place, time, season, temperature, humidity, etc.), and various activity data occurring within a/the mobile service (response to random posts having specific information, user-produced content, etc.), as a learning data.

After the algorithm is implemented as such, if at least one of the user's alcohol preference information, alcohol-and-food matching data, and user data is input to the first learning model, the curation data may be generated based on the item-based recommendation algorithm. Here, the item-based recommendation algorithm may be included in the first learning model.

More specifically, the first learning model may calculate a matching score with an/the alcohol based on the user data, for each of the at least one food(s) matched to an/the alcohol corresponding to the alcohol preference information, through the item-based recommendation algorithm, and a recommendation list may be created from the curation data in an order of high matching score (e.g., the order in which the matching score decreases).

Here, the user data may include at least one of the user's age, weighted value of gender preference, nationality, location, time, season, weather, temperature, humidity, product sales rate, search data on mobile services, page view data, internet posting creation data, community data, and payment data, account-related data, reaction data to posts written by other users, and content data directly produced by the user.

The processor (130) may calculate different matching scores between/among alcohol and food depending on the user data used.

Assuming that the alcohol corresponding to the user's alcohol preference information is Alcohol 1 and that there are 5(five) foods matching Alcohol 1, in an embodiment in which the user's gender is used as the user data, the matching score(s) of Foods 1 to 5 to Alcohol 1 may be calculated in the following descending order: Food 1, Food 3, Food 4, Food 2, and Food 5. Accordingly, the recommendation list may be created, sorted in the following order: Food 1, Food 3, Food 4, Food 2, and Food 5

Different from this, in an embodiment in which the user search data, page view data, reaction data to posts written by other users, and content data directly produced by users are used as the user data, the matching score(s) of Foods 1 to 5 to Alcohol 1 may be calculated in the following descending order: Food 3, Food 5, Food 2, Food 4, and Food 1. Accordingly, the recommendation list may be created, sorted in the following order: Food 3, Food 5, Food 2, Food 4, and Food 1.

Although not shown in FIG. 3, the method of the present disclosure may further comprise a step of searching for similar product (similar-product) data by using product data based on an artificial-intelligence-based third learning model (learning model B shown in FIG. 4).

Depending on an embodiment, when the product data is alcohol name information received from the user device (20), the similar product data may be searched by the third learning model learned or trained through data querying. That is, when the alcohol name information (text information) is input as the product data, the processor (130) may perform querying on the alcohol name information using the third learning model and the similar product data may be explored/searched through an application of Elastic Search Engine (inverted indexing, tokenizing, and NLP application).

Depending on an embodiment, when the product data is an alcohol image received from the user device (20), the similar product data may be searched by the third learning model learned through object detection and classification within the image. That is, when the alcohol image is input as the product data, the processor (130) may detect and classify objects in the image using the third learning model, extract the index, explore/search similar image index, and specify the object to explore/search the similar product data based on the index.

Depending on an embodiment, when the matching data for the alcohol corresponding to the user's alcohol preference information does not exist, the flavor data may be used to search for an alcohol similar to the (applicable) alcohol at hand, and food matched with the similar alcohol searched may also be recommended based on the matching score.

Depending on an embodiment, the processor (130) may receive evaluation data from the user device (20) through the communication unit (110). Here, the evaluation data may be data that quantifies a satisfaction level of the user who has received food recommendations for the user's favorite alcohol.

Such evaluation data may be used as additional learning data for at least one of the first learning model, the second learning model, and the third learning model. In this way, by using the evaluation data to update (relearn) the first learning model, second learning model, and third learning model, analysis results with higher accuracy may be provided.

The above disclosure of the first learning model, the second learning model, or the third learning model performing an operation is only for convenience of description. An actual operator may be the processor (130), and it may be understood that each operation may be performed through the first, second, or third learning model.

Detailed Description of Step S230

The processor (130) may output or display a first UI (User Interface) on the screen of the user device (20), wherein the first UI is configured to arranges an image of a food corresponding to a first or the highest rank (e.g., the food with the highest matching score or recommendation) in the recommendation list in a first region and to sequentially arrange images of foods corresponding to a second or second highest rank to a preset rank in a second region.

Referencing FIG. 8, the images and descriptions of preferred alcohol(s) may be arranged in A region, based on the alcohol preference information input by the user. The images and descriptions of the food ranked first in the recommendation list as to preferred alcohols may be arranged in B region. The images and descriptions of the foods ranked second to preset rank (e.g., fourth rank), and excluding the food(s) ranked first, in the recommendation list as to preferred alcohols may be arranged in C region.

Meanwhile, the present disclosure may recommend a food that matches the user's favorite alcohol, but may also recommend alcohols similar to the user's favorite alcohol.

In Step S220, the processor (130) may use the item-based recommendation algorithm to extract at least one recommended alcohol that has a flavor similar to the alcohol corresponding to the user's alcohol preference information; and calculate the matching score with the corresponding alcohol, for the at least one food matched to each of the recommended alcohol(s) based on the user data; and extract a food with the highest matching score as a recommended food with respect to each of the recommended alcohol(s).

In other words, if the alcohol corresponding to the user's alcohol preference information has a high proportion of flavor A and flavor B, the processor (130) may extract other alcohols with a high proportion of flavor A and flavor B, as similar recommended alcohols; and calculate the matching score for each food matched thereto and extract the recommended food. The method for calculating the matching scores and extracting the recommended food(s) may be the same as described above, but in this case, rather than creating a/the recommendation list containing a plurality of recommended foods, a single food with the highest matching score is recommended for each of the recommended alcohol(s).

In Step S230, the processor (130) may match each image of the recommended alcohol(s) and each image of the recommended food(s) extracted for each of the recommended alcohol(s) and display a second UI (User Interface) on the screen of the user device (20), wherein the second UI is configured to arrange the matched images in a third region.

Referring to FIG. 9, the images and descriptions of the recommended beer extracted based on the alcohol preference information input by the user may be arranged in D region. The images and descriptions of the recommended foods that go well with each of the recommended beer may be arranged in E region. In FIG. 9, only three recommended beers are displayed, but is not limited thereto and fewer or more recommended beers (i.e., alcohols) may be displayed.

Depending on an embodiment, the present disclosure may introduce other users with similar preferences/tastes to the (present) user through a service platform based on the user's alcohol preference information and other criteria/conditions preset by the user. Here, the preset criteria may be gender, ranking/levels within the platform, and frequency of drinking.

Depending on an embodiment, the present disclosure may provide restaurant information where the user may experience the recommended food paired with the user's favorite alcohol, based on the user's current location. More specifically, the processor (130) may search for a restaurant that sells alcohol corresponding to the alcohol preference information input by the user and the recommended food paired with the alcohol, among restaurants within a preset distance from the user's current location; the location information of the restaurant may be displayed on the screen of the user device(20).

In this way, the present disclosure may recommend food that matches the user's alcohol preference, but also provide a higher level of personalized recommendation by considering the matching data between alcohol and food pre-/readily generated through learning of the learning models and other various parameters and variables related to the user.

In the description above, it was described that the alcohol preference information is input from the user device (20), and that a/the food that matches the user's alcohol preference is recommended, or that the alcohol similar to the user's alcohol preference is recommended. However, the present disclosure may be implemented to receive the food preference information from the user device (20), then recommend an alcohol that matches the user's food preference, or recommend a food similar to the user's food preference. Even when implemented in such forms, the processes (steps) described above may be applied in the same way.

FIG. 3 describes the steps as being sequentially executed, but this is merely an illustrative description of the technical idea of the present embodiment, and those skilled in the art will not deviate from the essential characteristics of the embodiment. Since the steps shown in FIG. 3 may be altered and modified in various ways by changing the order of the steps or executing them in parallel, the steps shown in FIG. 3 are not limited to a time-series or time-serial order.

In the above description, the steps described in FIG. 3 may be further divided into additional steps or combined into fewer steps, depending on the implementation of the present disclosure. Additionally, some steps may be omitted or the order between steps may be changed as needed.

The disclosed embodiments may be implemented in the form of a recording medium that stores instructions executable by a computer. The instructions may be stored in the form of program code, and when executed by a processor, may create program modules to perform operations of the disclosed embodiments. The recording medium may be implemented as a computer-readable recording medium.

The computer-readable recording medium includes all types of recording media storing instructions that may be decoded by a computer. For example, there may be Read Only Memory (ROM), Random Access Memory (RAM), magnetic tape, magnetic disk, flash memory, and optical data storage device, etc.

Disclosed embodiments have been described as above, with reference to the attached drawings. Those skilled in the art where the disclosure pertains to, will understand that the embodiments may be easily altered or modified in other particular forms, without changing the technical spirit or essential characteristics of the present disclosure. The disclosed embodiments are for exemplary and illustrative purposes, and accordingly, the embodiments disclosed above must not be interpreted as limiting.

The scope of the present disclosure is shown by the claims that follow, and it must be interpreted that all modifications or modified, altered forms derived from meaning, scope, and the equivalence principle of the claims are included in the scope of the present disclosure.

### REFERENCE NUMERALS

10: Service Server
20: User Terminal/Device
30: External Device
100: Curating Device
110: Communication Unit
120: Memory
130: Processor

1. A method for curating alcohol and food based on flavor data using a plurality of artificial intelligence models, comprising:
receiving a food recommendation request including a user's alcohol preference information from a user device;
generating curation data by using at least one of the alcohol preference information, pre-stored matching data between alcohol and food, and user data, based on an artificial-intelligence-based first learning model; and
displaying information as to recommended food on a screen of the user device, by using the curation data;
wherein the matching data is generated by an artificial-intelligence-based second learning model learning a plurality of alcohol data and a plurality of food data according to a preset correlation based on the flavor data.

2. The method for curating alcohol and food based on flavor data using a plurality of artificial intelligence models according to claim 1, wherein
the artificial-intelligence-based second learning model is learned so that a first probability that a first alcohol and a first food are related and a second probability that a second alcohol and the first food are related are different on a graph network.

3. The method for curating alcohol and food based on flavor data using a plurality of artificial intelligence models according to claim 1, further comprising:
searching similar-product data by using product data, based on an artificial-intelligence-based third learning model.

4. The method for curating alcohol and food based on flavor data using a plurality of artificial intelligence models according to claim 3, wherein
when the product data is alcohol name information received from the user device, the similar-product data is searched by the third learning model learned through data querying; and
when the product data is an alcohol image received from the user device, the similar-product data is searched by the third learning model learned through object detection and classification within the image.

5. The method for curating alcohol and food based on flavor data using a plurality of artificial intelligence models according to claim 1, wherein
for the step of generating curation data,
the curation data related to at least one food that suits the user's alcohol preference is generated based on an item-based recommendation algorithm.

6. The method for curating alcohol and food based on flavor data using a plurality of artificial intelligence models according to claim 5, wherein
the item-based recommendation algorithm calculates a matching score with an alcohol for each of the at least one food matched to the alcohol corresponding to the alcohol preference information, based on the user data, and creates a recommendation list from the curation data with the matching score arranged in descending order or rank.

7. The method for curating alcohol and food based on flavor data using a plurality of artificial intelligence models according to claim 6, wherein
for the step of displaying information as to recommended food,
a first User Interface (UI) is displayed on the screen and configured:
to arrange an image of a food corresponding to a first or the highest rank in the recommendation list in a first region, and
to sequentially arrange images of foods corresponding to a second or second highest rank to a preset rank in the recommendation list in a second region.

8. The method for curating alcohol and food based on flavor data using a plurality of artificial intelligence models according to claim 6, wherein:
for the step of generating curation data,
the item-based recommendation algorithm is used and at least one recommended alcohol that has a flavor similar to the alcohol corresponding to the user's alcohol preference information is extracted, and the matching score with the corresponding alcohol is calculated for the at least one food matched to each of the recommended alcohols, based on the user data, and the food with a highest matching score is extracted as the recommended food with respect to each of the recommended alcohols; and
for the step of displaying information as to recommended food,
a second User Interface (UI) is displayed on the screen and configured to match each image of the recommended alcohols and each image of the recommended foods extracted for each of the recommended alcohols, and arrange the matched images in a third region.

9. The method for curating alcohol and food based on flavor data using a plurality of artificial intelligence models according to claim 1, wherein:
the correlation is configured and set by giving a priority or rank to a plurality of food flavors that are correlated to/for an alcohol flavor, in descending order of the correlation.

10. The method for curating alcohol and food, based on flavor data using a plurality of artificial intelligence models according to claim 9, wherein
the matching data is generated, for a specific or given alcohol, by matching for each of main alcohol flavors of the specific alcohol,
a first food having a food flavor with the correlation of highest rank at more than a first preset proportion and
a second food having a food flavor with the correlation of second highest rank at more than a second preset proportion.

11. A computer program, which is stored in a computer-readable recording medium for executing the method of claim 1.

12. A device for curating alcohol and food, based on flavor data using a plurality of artificial intelligence models, comprising:
a communication unit;
a memory, storing at least one process for curating alcohol and food, based on flavor data using a plurality of artificial intelligence models; and
a processor, operating steps according to the process;
wherein the processor receives a food recommendation request containing a user's alcohol preference information from a user device through the communication unit, and based on the artificial-intelligence-based first learning model, generates a curation data by using at least one of the alcohol preference information, pre-stored matching data between alcohol and food, and user data, and displays information about recommended food on the screen of the user device, by using the curation data; and
wherein the matching data is generated by an artificial-intelligence-based second learning model, learning a plurality of alcohol data and a plurality of food data based on a correlation, which is preset based on the flavor data.

13. The device for curating alcohol and food, based on flavor data using a plurality of artificial intelligence models according to claim 12, wherein
the processor generates food recommendation curation data related to at least one food that suits the user's alcohol preference, based on an item-based recommendation algorithm, and
for each of one or more foods matched to an alcohol corresponding to the alcohol preference information, the item-based recommendation algorithm calculates a matching score with the alcohol based on the user data, and generates a recommendation list as the food recommendation curation data in a descending order of the calculated matching score.

14. The device for curating alcohol and food, based on flavor data using a plurality of artificial intelligence models according to claim 12, wherein
the correlation is configured and set by giving a priority or rank to a plurality of food flavors that are correlated to/for each alcohol flavor, in descending order of the correlation,

15. The device for curating alcohol and food, based on flavor data using a plurality of artificial intelligence models according to claim 14, wherein
the matching data is generated, for a specific or given alcohol, by matching for each of main alcohol flavors of the specific alcohol,
a first food having a food flavor with the correlation of highest rank at more than a first preset proportion and
a second food having a food flavor with the correlation of second highest rank at more than a second preset proportion.
